(19) United States
(12) Patent Application Publication
(10) Pub. No.: US 2002/0054156 A1
(43) Pub. Date: May 9, 2002

(54) APPARTUS AND METHOD FOR CONTROLLING A MENU, AND STORAGE MEDIUM RECORDING SAME

(76) Inventors: TAEKO KOIZUMI, KANAGAWA (JP); KAZUTOSHI CHIBA, KANAGAWA (JP)

Correspondence Address: STAAS & HALSEY, 700 ELEVENTH STREET NW SUITE 500, WASHINGTON, DC, 20001

(21) Appl. No.: 09/166,899

(22) Filed: Oct. 6, 1998

(30) Foreign Application Priority Data
Oct. 7, 1997 (JP) 09-274017

(51) Int. Cl. G06F 3/00

(52) U.S. Cl. 345/835

(57) ABSTRACT

An apparatus for controlling a menu including an icon display control section for displaying a first icon corresponding to a first function in relation to a second function within a second icon corresponding to the second function. A function control section executes the function corresponding to the icon selected from the first and second icons being displayed.

### FIELD OF THE INVENTION

The present invention relates to a computer, such as a word processor, for displaying a plurality of icons corresponding to different functions on an initial image of a display unit, and in particular, to a menu control apparatus, menu control method and storage medium storing the program for displaying icons on a menu image.

### BACKGROUND OF THE INVENTION

In recent years, word processors are generally provided with document editing functions, as well as a number of other versatile functions. As a result, numerous icons, corresponding to the functions, are displayed as an initial image on the display unit in order to enable a user to instruct the execution of each function. As the number of functions contained in the word processors increase, so too do the number of icons displayed, thereby crowding the initial image.

Additionally, such images appearing on the initial image can also be displayed on other menu images. That is, when an initial image is selected, icons corresponding to processes of selected functions are displayed and the resulting menu image becomes crowded.

Even in a computer system, such as a personal computer having the basic hardware structure similar to that of a word processor, a program displaying icons corresponding to each application program and function is installed so that a user can easily start up the application programs and execute the functions.

FIG. 1 is an exemplary prior art diagram showing a word processor as an example of the computer system to display a menu image formed of icons.

The apparatus shown in FIG. 1 illustrates a word processor generating various documents. The apparatus includes main unit 1, keyboard 2 and display unit 3. As shown in FIG. 1, the word processor is provided, in addition to the document editing function, with various functions such as a postcard function (for example, exclusive processing function for postcard documents of new year's greeting, summer greeting and other greetings) and a communication function (for example, an access function to server using the Internet, a FAX function, etc.).

Examples of the processing functions described above will now be described. The document editing function includes generation of a new document, edition of a generated document and printing of documents. The postcard function includes generation of a new year postcard and generation of a greeting postcard. The communication function includes browsing of the WWW (Word Wide Web), transmission and reception of electronic mail (E-mail) and transmission and reception of a FAX.

The processes executed by each function, the icons corresponding to respective functions which are prepared, and the menu image in relation to the functions and in relation to processes of the functions are given a hierarchical structure.

In order to execute the functions (processing functions), a plurality of icons corresponding to respective functions are displayed as an initial image on the display unit 3. A user can select the desired function by selecting the icon displayed corresponding to the desired function.

For example, as shown in FIG. 1, when a user selects the desired icon on the initial image (menu image), for example, a document icon corresponding to a document editing function, a postcard icon corresponding to a postcard function or a communication icon corresponding to a communicating function, the function corresponding to the selected icon is activated.

When a touch panel is provided to the display unit 3 as an input device for the selecting operation, the desired icon can be selected when a user touches, with a finger or a stylus pen, the position where the desired icon is displayed. When a touch panel is not provided, the desired icon can be selected by operating the keyboard 2 or mouse (not illustrated) to move the cursor displayed on the image to the desired icon, and then executing key operation or clicking the button of mouse.

When a specific function is selected from the menu image by a user, the main unit 1 displays, on the display unit 3, the menu image having a plurality of icons corresponding to each processing function in relation to the selected function.

A user is now able to execute the desired processing function by selecting a desired icon from the menu image displayed on the display unit 3.

As described above, one icon is displayed for one function in the prior art. In the menu image, icons corresponding to each function that may be selected are displayed. When one function (icon) is selected, the menu image for selecting the processing function corresponding to the selected function (including the icons corresponding to each processing function) is displayed.

The prior art, however, has the following problems. In a conventional computer system, such as the word processor described above, the icons corresponding to the preset number of functions are displayed on the display unit as the initial image (menu image). Hence, a user can operate the function corresponding to the selected icon by selecting the desired icon from amongst the displayed icons. However, only one icon is displayed for one function or process. Therefore, each icon corresponding to the number of functions or processes are displayed on the initial image (menu image).

As described above, since the icons are displayed in the initial image or in another menu image, it is difficult for a user to find and execute a specific icon. As the number of functions increase, so too do the number of icons to be displayed on the menu image, resulting in complicated and crowded images. Hence, the application flexibility becomes complicated.

A similar problem occurs when the number of application programs which may be executed in the computer system increases, whereby the number of icons to be used to instruct the start of each application program displayed on the menu image also increases.

### SUMMARY OF THE INVENTION

It is therefore an object of the present invention to provide a menu control apparatus, menu control method and a computer-readable storage medium storing the programs in which the problems of the prior art can be solved and complicated images can be eliminated to assure application flexibility even when the number of functions, processes or application programs to be executed increases.

It is a detailed object of the present invention to provide an apparatus for controlling a menu including an icon display control section. The icon display control section displays a second icon corresponding to a second function in relation to a first function within the first icon corresponding to the first function. A function control section executes the function corresponding to the icon selected from the first and second icons being displayed.

According to an embodiment of the present invention, a multi-function apparatus is achieved in which as the number of functions increases, the number of icons to be displayed in the menu is not increased, eliminating crowded images.

It is another object of the present invention to provide an apparatus including an icon display control section to display, within the first icon defined as a large classification, the second icon defined as small classification belonging to the large classification and the function control section to execute the function corresponding to the icon selected from the first and second icons being displayed.

According to another embodiment of the present invention, the user becomes aware of the icons for large classification of various functions and the icons for small classification for characterizing each function. Hence, visual recognition of the icons eliminates crowded images by preparing the icons indicating a small and large classification of the functions and processes to be characterized in such icons. Moreover, when a certain function is provided as a hidden function, it can be expected that such function can attract interest of the users.

It is another object of the present invention to provide an apparatus including an icon display control section for displaying, in the first icon corresponding to the first function, the second icon corresponding to the second function in relation to the first function and the function control section for executing the function corresponding to the icon selected from the first and second icons being displayed, wherein the second icon is displayed in a second menu located in a lower hierarchical level of a first menu and the first and second icons are displayed in the first menu.

According to an embodiment of the present invention, since the icons displayed in the menu of a lower hierarchical level are displayed in the menu of a higher level, the operation to select the icon for displaying the lower level menu from the menu of the higher level and to select the desired icon from the menu of the lower level being displayed are no longer required. That is, the icons of the lower level menu can be selected directly from the higher level menu.

Accordingly, a user can select the icons corresponding to the desired functions, and processes can be selected with fewer operations.

It is a further object of the present invention to provide a menu control method for displaying, within a first icon corresponding to a first function, a second icon corresponding to a second function in relation to the first function to execute the function corresponding to the icon selected from the first and second icons being displayed.

According to one method of the present invention, one icon is capable of controlling a number of functions, even as the number of functions increases. Hence, crowded images can be eliminated, without an increase in the number of icons displayed on the menu.

It is still a further object of the present invention to provide a method for displaying, within the first icon defined as the large classification, the second icon defined as the small classification belonging to the large classification to execute the function corresponding to the icon selected from the first and second icons being displayed.

According to another method of the present invention, a user views the icons in the large classification of various functions and in the small classification for characterizing each function. In this regard, visual recognition of the icons eliminates complicated images by preparing the icons in the form of small and large classifications of the functions and processes characterized by the icons. Moreover, when a function is hidden, it can be expected that such function will attract the interests of the users.

It is still a further object of the present invention to provide a method to display, within the first icon corresponding to the first function, the second icon corresponding to the second function in relation to the first function and.execute the function corresponding to the icon selected from the first and second icons being displayed, wherein the second icon is displayed in the second menu located in the hierarchically lower level of the first menu and the first icon and second icon are displayed in the first menu.

According to another method of the present invention, since the icons to be displayed in the menu of a lower level are displayed on the menu of a higher level, it is no longer necessary for the user to select the icon to display the lower level menu from the higher level menu and to select the desired icon from the lower level menu. That is, the icon of the lower level menu can be selected directly from the higher level menu. Therefore, a user can select and process the icon corresponding to the function with fewer operations.

It is still a further object of the present invention to provide a computer-readable storage medium having a program recorded thereon including the procedures for displaying, within a first icon corresponding to a first function, a second icon corresponding to a second function in relation to the first function and the procedures for executing the function corresponding to the icon selected from the first and second icons being displayed.

According to one embodiment of the storage medium of the present invention, a multi-function computer eliminates complicated images without increasing the number of icons to be displayed on the menu, even when the number of functions increase.

It is still a further object of the present invention to provide a computer-readable storage medium having a program recorded thereon for displaying, in the second icon defined as the large classification, the first icon defined as the small classification belonging to the large classification and executing the function corresponding to the icon selected from the first and second icons being displayed.

According to an embodiment of the present invention, a user views the icons of the small and large classification of various functions. In this regard, visual recognition of the icons eliminates complicated images by preparing the icons in the form of small and large classifications of the functions and processes characterized by the icons. Moreover, when a function is hidden, it can be expected that such function will attract the interests of users.

It is still a further object of the present invention to provide a computer-readable storage medium having a program recorded thereon for displaying, in the first icon corresponding to the first function, the second icon corresponding to the second function in relation to the first function, executing the function corresponding to the icon selected from the first and second icons being displayed, wherein the second icon is displayed in a second menu located in the lower hierarchical level of a first menu and the first icon and second icon are displayed in the first menu.

According to another embodiment of the present invention, since the icons to be displayed in the lower level menu are displayed in the higher level menu, it is no longer necessary for a user to select the icon for displaying the lower level menu from the higher level menu and to select the desired icon from the lower level menu. That is, the icon of the lower level menu can be selected directly from the higher level menu.

Accordingly, a user can select and process the icon corresponding to the desired function with fewer operations.

### BRIEF DESCRIPTION OF THE DRAWINGS

FIG. 1 is an exemplary diagram explaining the prior art.

FIG. 2 is an exemplary diagram of the present invention.

FIG. 3 is an exemplary diagram illustrating a word processor of the present invention.

FIG. 4 is an exemplary diagram illustrating a hardware structure of the word processor of the present invention.

FIG. 5 is an exemplary diagram of the image and icons displayed on the display unit of the word processor of the present invention.

FIG. 5(a) illustrates an example of an initial image.

FIG. 5(b) illustrates an example of icons displayed in FIG. 5(a).

FIG. 5(c) illustrates an icon corresponding to an Internet function.

FIG. 6 is an exemplary diagram explaining the control required for the operation of icons.

FIG. 7 is an exemplary diagram explaining the data format of icons of the present invention.

FIG. 8 is an exemplary diagram illustrating a flowchart explaining the processes for selecting icons in relation to the present invention.

FIG. 9 is an exemplary diagram indicating a practical example of icons in relation to the present invention.

FIG. 10 is an exemplary diagram indicating an example of a menu displayed after the “communication” icon of the menu is selected in relation to the present invention.

FIG. 11 is an exemplary diagram indicating an example of the menu displayed after the “Internet” icon of the menu is selected in relation to the present invention.

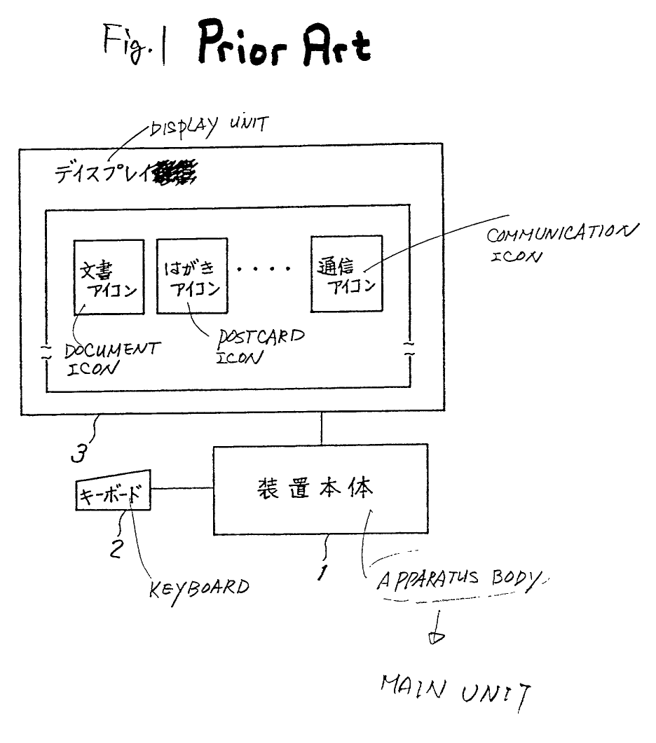

### DETAILED DESCRIPTION OF THE PREFERRED EMBODIMENTS

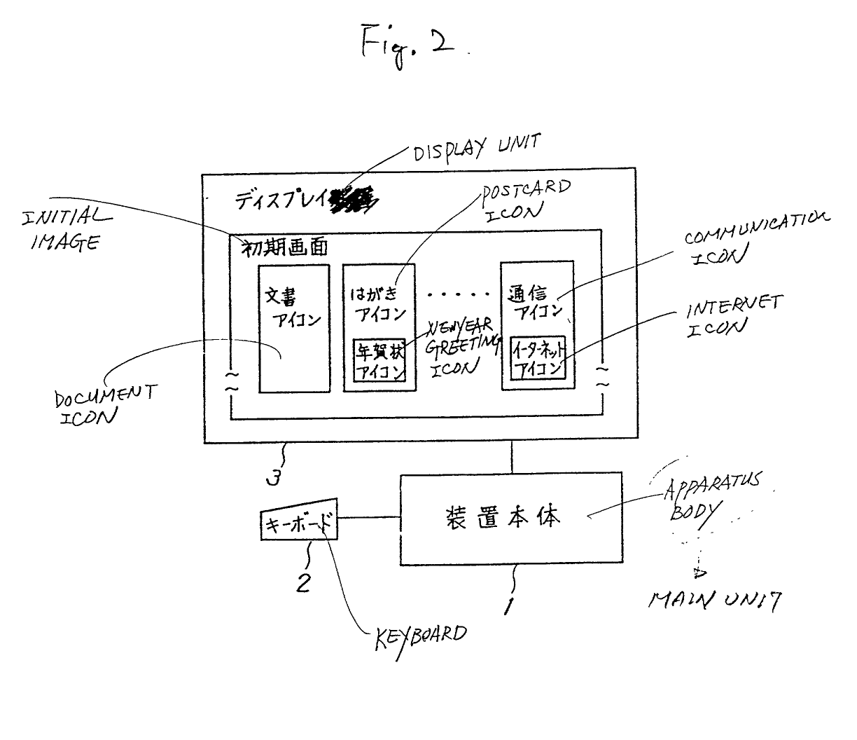

FIG. 2 is an exemplary diagram of the present invention. FIG. 2 illustrates a main unit 1; a keyboard 2; and a display unit 3. In order to attain the objects described above, the present invention is structured as described below.

(1) Multiple functions can be executed for one icon by displaying another icon within the icon. In this regard, a number of icons corresponding to respective functions may be displayed on the screen of the display unit 3 as a menu.

(2) In the structure of item (1), a first function is defined as a small classification, and a second function is defined as a large classification. The small classification belongs to the large classification and displays the icon of the small classification within the icon of the large classification.

(3) In the structure of item (1) or (2), an icon displayed in a first menu image and in a second menu image, located in a lower hierarchical level of the first menu image, can be displayed as a second icon.

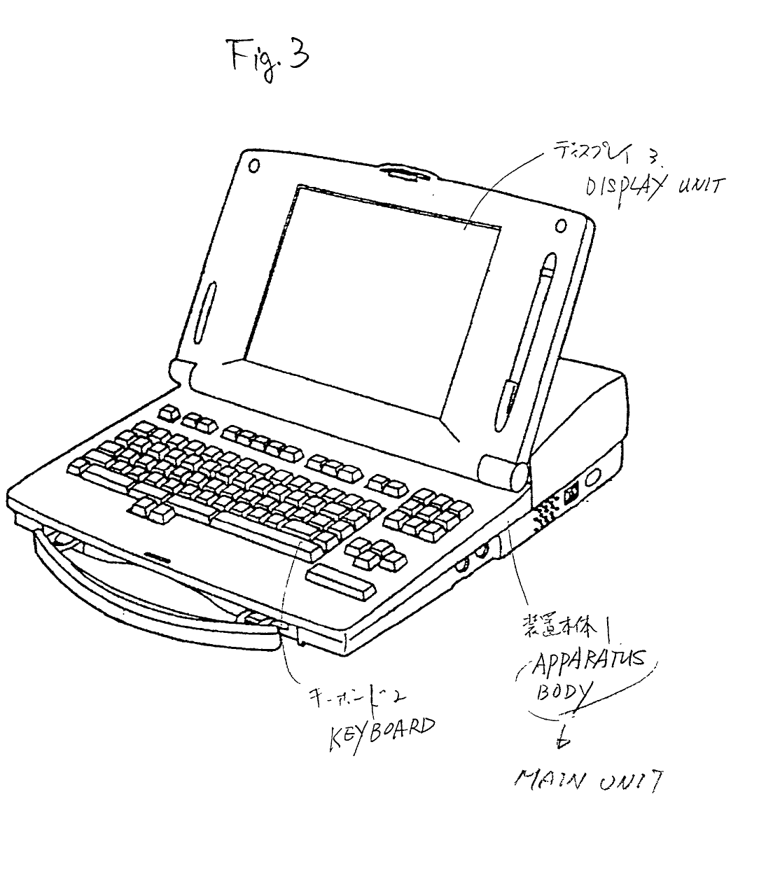

FIG. 3 is an exemplary diagram illustrating a word processor of the present invention. The apparatus shown in FIG. 3 is an example of the word processor which includes, for example, main unit 1, keyboard 2 and display unit 3.

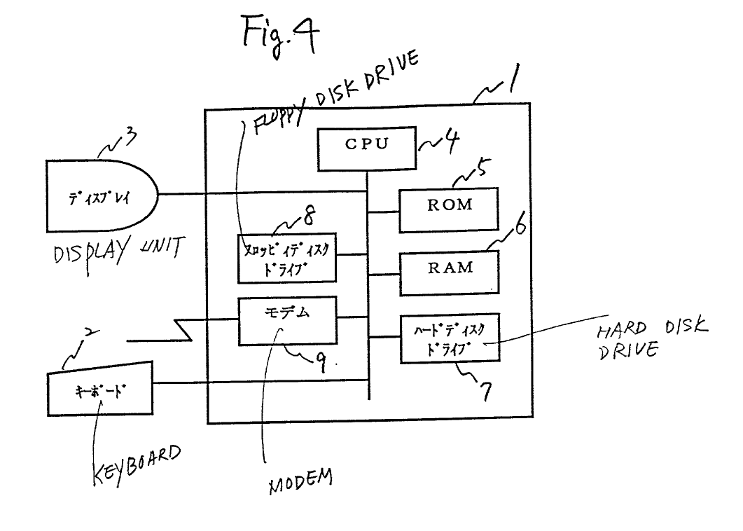

As shown in FIG. 4, the main unit 1 is formed of the hardware including, for example, CPU (central processing unit) 4, ROM 5, RAM 6, hard disk drive 7, floppy disk drive 8 and modem 9. An internal bus connects these elements. Interfaces (not illustrated) for the keyboard 2 and display unit 3 are also provided.

The CPU 4 is, for example, a processor for executing controls and processes in the word processor. ROM 5 is, for example, a non-volatile memory storing programs, parameters and other various data to be executed by CPU 4. The programs of this invention are also stored in this ROM 5. The RAM 6 is, for example, a memory used for temporary storage of data for work in the controls and processes by the CPU 4.

Moreover, as described with reference to the prior art, a touch panel arranged on the display unit 3 may also be provided as an input device. The following example illustrates a use of the apparatus, wherein a touch panel is used as the input device.

Additionally, an auxiliary memory device, such as a hard disk drive 7 and a floppy disk drive 8, may also be provided. The memory device is used to record the generated document to the storage medium (i.e. hard disk and floppy disk) or to read the document or program stored in the storage medium. A modem 9 may be used to access a remote server using, for example, the Internet, execute transmission and reception of, for example, an E-mail, and transmission and reception of data by, for example, a FAX through a telephone line.

The computer system includes, for example, the hardware described above, an operating system and software, such as a device driver, to operate the devices, such as a display unit and keyboard.

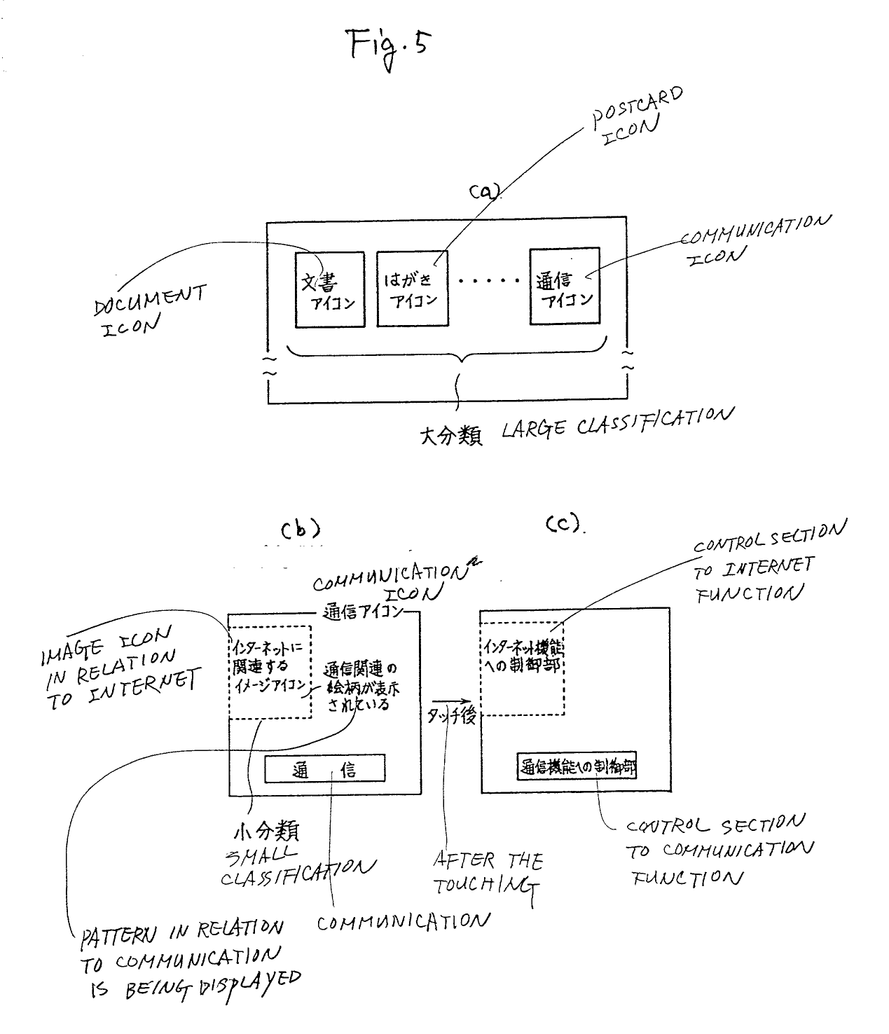

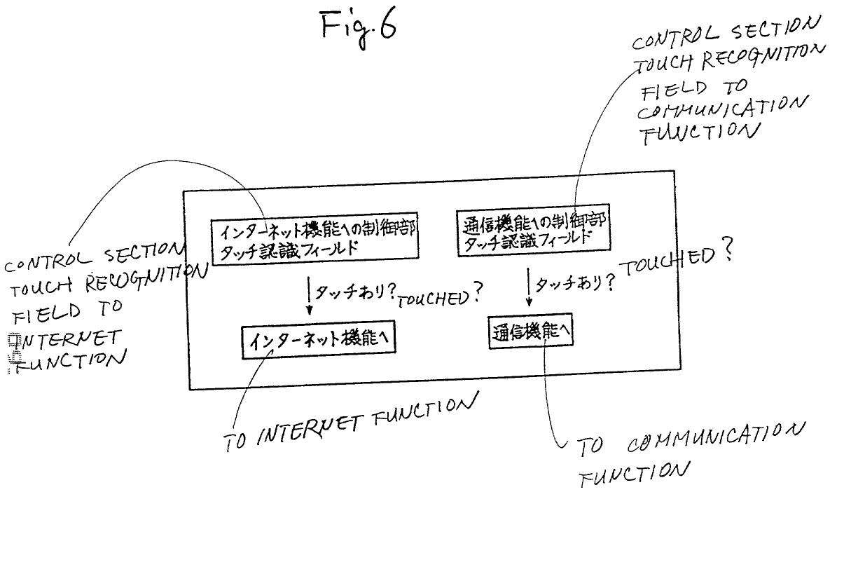

FIG. 5 is an exemplary diagram explaining the image and icons displayed on the display unit of the word processor of the present invention. FIG. 5(a) illustrates an example of an initial image, FIG. 5(b) illustrates an example of icons displayed in FIG. 5(a), and FIG. 5(c) illustrates an icon corresponding to an Internet function. FIG. 6 is an exemplary diagram explaining the control required for the operation of icons.

The word processor displays the initial image, as shown in FIG. 5(a), on the display screen of the display unit 3 when the power is turned ON. In the initial image, icons corresponding to respective functions (processing functions) of the word processor are displayed. These icons include, for example, the document icon corresponding to the document editing function, the postcard icon corresponding to postcard function and the communication icon corresponding to communication function. Respective functions corresponding to these icons are defined on the basis of large classification. The icons of large classification are displayed using patterns indicating the corresponding functions.

Processing of each function is similar to the prior art, and, hence, the same explanation is not repeated.

An icon corresponding to, for example, the Internet function may be displayed, as illustrated in FIG. 5(b). The icon, in this case, enables users frequent and easy access to the Internet.

As shown in FIG. 5(b), an image icon (a pattern in relation to a communication is displayed) in relation to the Internet is displayed based on the small classification of the detailed classification within the communication icon.

As described above, a specific icon (for example, a “communication icon”) is set to indicate the large classification and functions related to the large classification, and in particular, characterizes the function itself. The functions indicate the detailed classification thereof (for example, functions using the Internet, etc.) and are set as the small classification or detailed classification using patterns for discrimination against each part of the icon. Each part, as described above, is displayed as a pattern corresponding to the relevant function.

Similar to the example described above, an icon (for example, an Internet icon), belonging to the small classification or detailed classification, is displayed in one icon (for example, a “communication icon”) belonging to the large classification. Hence, when the number of functions increases, execution or transition of the functions may be made without increasing the number of icons belonging to the large classification.

For example, as shown in FIG. 5 (b), when the “image icon in relation to the Internet” (displayed with a pattern) is displayed within the “communication icon” (displayed with a pattern), a user selects either the “communication icon” or the “image icon in relation to the Internet”. For example, when a user selects the “image icon in relation to the Internet”, the control section (program) for the Internet function is activated and the user is connected to the Internet.

In this case, the icon could be selected, as described above, by touching the image in which the relevant icon is displayed, using, for example, the touch panel. In other cases, for example, the icon can be selected by moving the cursor to instruct the selection.

When a user selects the “communication icon”, the control section (program) for the communication function is activated, and a communication function other than the Internet is activated (for example, a facsimile communication).

When a user selects a desired icon, as described above, the control section (program) corresponding to each icon is activated to control the relevant function. This function is structured, as shown in FIG. 6. For example, when the “Internet icon” is arranged in the “communication icon”, the touch recognition field or cursor designation field for selecting the “communication icon”, and the touch recognition field or cursor designation field for selecting the “Internet icon” are set on the display screen.

A user starts the control section (program) to control the desired function by designating the touch field or cursor designation field. For example, when a user touches the control section touch recognition field for the Internet function, the Internet function is started. Similarly, when a user touches the control section touch recognition field for the communication function, the communication function is started.

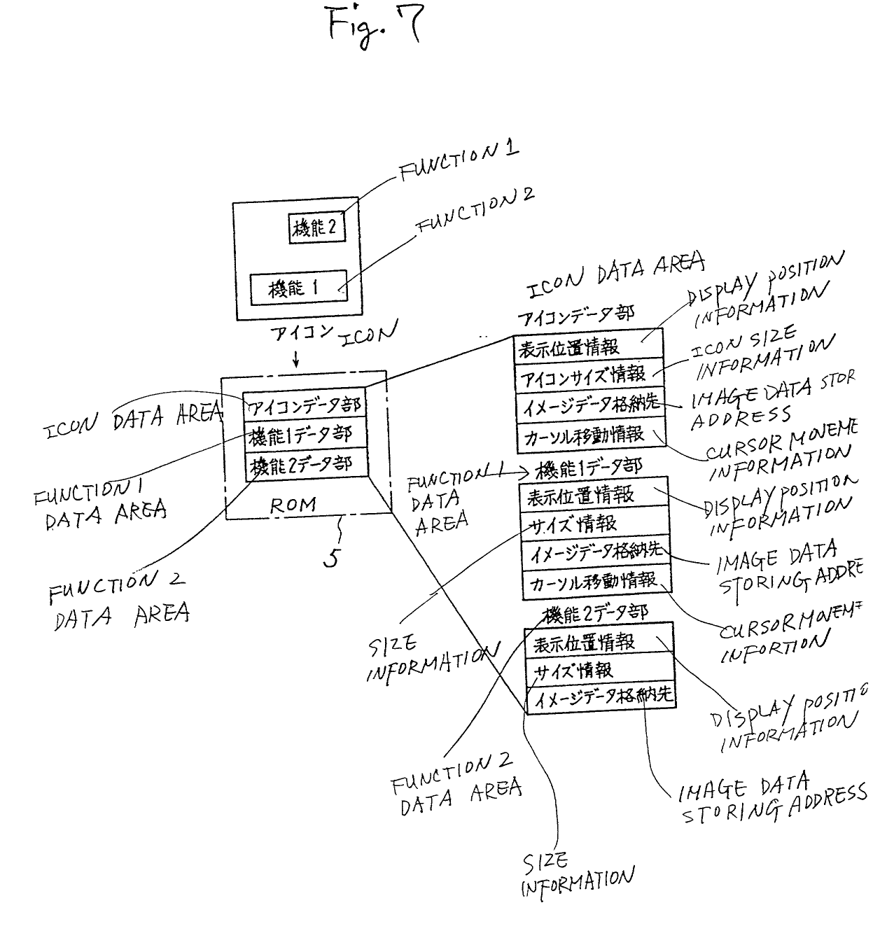

FIG. 7 is an exemplary diagram illustrating the data format of icons of the present invention. The data of the icons described above have the data format as shown in FIG. 7 in order to start the control section (program) for displaying each icon, executing each function corresponding to the icon and transitioning each function.

As described above, icons belonging to the large classification are displayed in the initial image, and icons belonging to the small classification or detailed classification are displayed in the icon belonging to the voluntary large classification. In FIG. 7, the icon (for example, the “communication icon”) belonging to the large classification is shown as “function 1”, and the icon (for example, the “Internet icon”) belonging to the small classification or detailed classification is shown as “function 2”.

Data of the icon (i.e., data to display the icon or control the function corresponding to the icon) is stored in the ROM 5. CPU 4 reads the icon data from the ROM 5, and controls displaying icons on the display unit by using the data. In this case, the data format of the icon corresponding to the large classification includes the icon data area, function 1 data area and function 2 data area.

The icon data area has data for displaying the icon on the display screen and includes, for example, display position information (information about display position on the display image), icon size information (information about display size of the icon), image data storing address data (address in the ROM 5 storing image data as the pattern of the icon) and cursor moving information (information used when an input device other than the touch panel is used).

The function 1 data area includes, for example, the display position information (information about display position on the display image), size information (information about the display size of the icon), image data storing address data (address in the ROM 5 storing image data as the pattern of the icon) and cursor moving information. The function 2 data area includes, for example, the data such as display position information, size information and image data storing address.

The icon data is stored in the ROM 5 for every large classification and function. The CPU 4 reads the necessary data from the ROM 5 for processing and control, when the display icons on the initial image or each menu image are selected by the user.

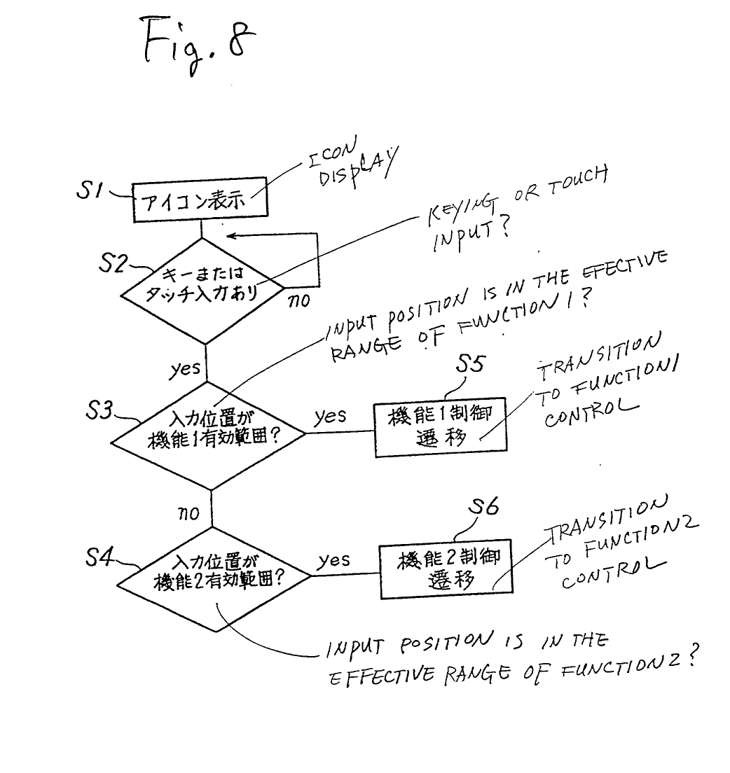

FIG. 8 is an exemplary diagram illustrating a flowchart explaining the process of icon selection of the present invention.

When a user turns ON the power of the word processor, the CPU 4 reads the data required for displaying an icon from the ROM 5, and displays the icons on the initial image (step S1). Thereafter, a user selects the icon corresponding to the desired function in the display.

When a user selects an icon from the icons displayed in the initial image, the control section (program) corresponding to the selected icon is started. That is, the CPU 4 determines whether there is a key input or a touch input (step S2). When the key input or the touch input is made (the icon is selected), the CPU 4 determines whether the input position is within the effective range of the function 1 (in the range of the designation field of the icon of function 1) (step S3).

When the input position is within the effective range of function 1, transition is made to the control section of the function 1 (step S5). That is, the program to control the function 1 is started. If the input position is not within the range of function 1, the CPU 4 determines whether the input position is in the effective range of function 2 (step S4).

When the input position is within the effective range of function 2, transition is made to the control section of function 2 (step S6). That is, the program to control function 2 is started.

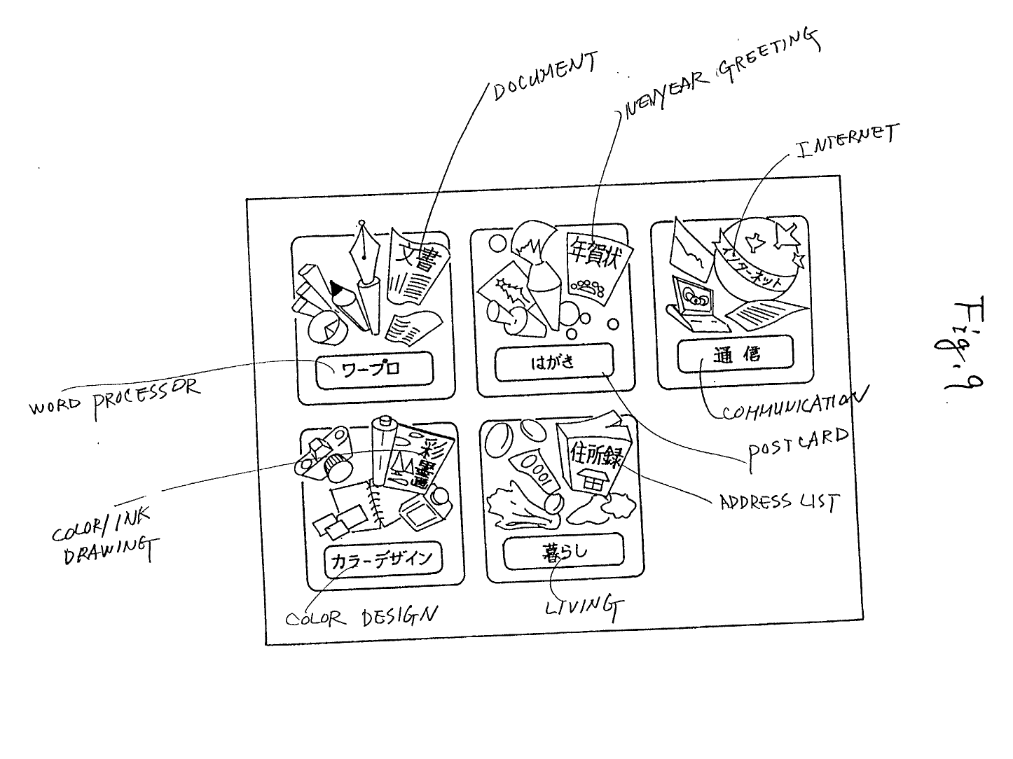

FIG. 9 is an exemplary diagram illustrating a practical example of the icons of the present invention.

In this example, the icons, for example, of the “Word processor”, “Postcard”, “Communication”, “Color design” and “Living” are displayed in the initial image as the icons belonging to the large classification. In each icon belonging to the large classification, the icon belonging to the small or detailed classification is also displayed.

That is, the “Document” icon belonging to the small or detailed classification is displayed in the “Word processor” icon, while the “New year greeting” icon belonging to the small or detailed classification is displayed in the “Postcard” icon. The “Internet” icon belonging to the small or detailed classification is displayed in the “Communication” icon, the “Color/ink drawing” icon belonging to the small or detail classification is displayed in the “Color design” icon, and the “Address list” icon belonging to the small or detailed classification is displayed in the “Living” icon.

When the Internet icon, for example, is selected from the icons, the control section (program) controlling the Internet function is started, and various processes utilizing the Internet can be selected.

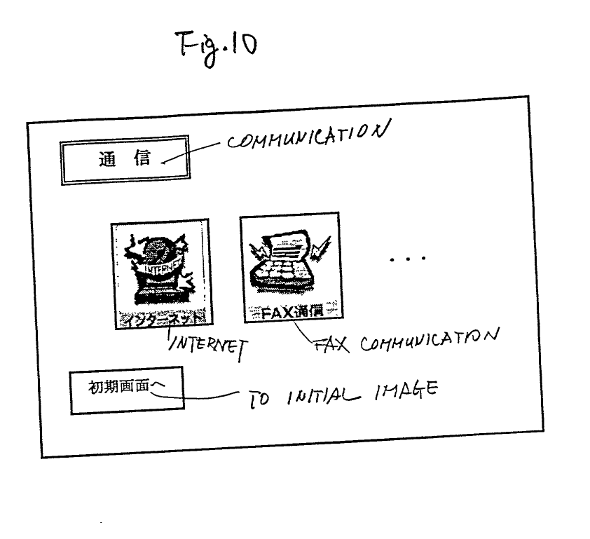

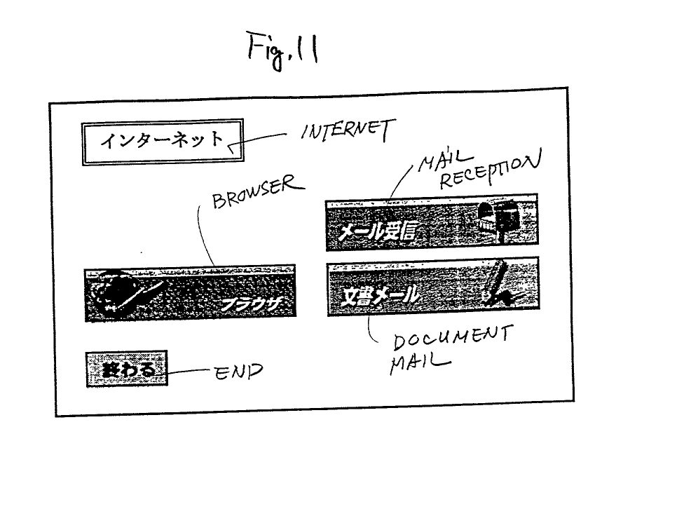

FIGS. 10 and 11 show the menu images. More specifically, FIG. 10 illustrates the menu image after the “Communication” icon in the initial image is selected, and FIG. 11 illustrates the menu image after the “Internet” icon in the initial image is selected.

FIG. 10 illustrates an example of the menu image, which is displayed after the “Communication” icon of FIG. 9 is selected. In this menu image, the icons respectively correspond to the “Internet” and “FAX communication” functions of the small or detailed classification belonging to the communication function. The “Internet” and “FAX communication” functions are similar to those described above.

As shown in the menu image of FIG. 10, an icon corresponding to functions executing the “Internet” function is displayed in the initial image of FIG. 9. The “FAX Communication” icon is also displayed on the menu image after the “Communication” icon is selected.

FIG. 11 illustrates an example of the menu image displayed after the “Internet” icon, displayed together with the “FAX communication” icon of FIG. 9, is selected. In this menu image, the icons corresponding to the small or detailed classification belonging to the Internet function are displayed. That is, the “Browser”, “Mail reception” and “Document mail” icons are displayed.

When the “Browser” icon is selected, the program to execute WWW browsing using the Internet is started. Moreover, when the “Mail reception” icon is selected, the program for executing the reception of E-mail utilizing the Internet is started, and when the “Document mail” icon is selected the program for transmitting E-mail utilizing the Internet is started.

The menu image shown in FIG. 11 is displayed after the “Internet” icon, displayed together with the “Communication” icon of FIG. 9, is selected. The menu image is also displayed after the “Internet” icon, displayed in the menu image of FIG. 10, is selected.

The present invention described above may be controlled with a program for executing the computer, such as word processor. With the control of the program, the CPU 4 of the computer sets one icon (for example, a “Communication icon”) to indicate the large classification. Also set are the function for characterizing and the function (for example, the function utilizing the Internet) indicating the small classification through discrimination with patterns at each part of the relevant icon as the small or detailed classification in view of executing the procedures for displaying these icons for transition to execution of the relevant function.

Such processes can be realized when the CPU 4 reads and executes the program and data stored in the ROM 5. However, the present invention is not limited to this example and realizes such processes, for example, by the following manners.

(1) The program stored in a floppy disk is read by a floppy disk drive of the word processor, and then stored into the RAM 6 of the word processor. The process described above could also be realized when the CPU 4 reads and executes the program stored in the RAM 6. Moreover, it is also possible that the program of the present invention recorded in the storage medium (such as floppy disk and CD-ROM) is read with a drive device corresponding to the storage medium, and it is then stored in the hard disk drive 7. The program is then stored to the RAM 6 to execute the process described above.

(2) The program transmitted from the other apparatus via the communication line, such as LAN and telephone line, is received by the word processor (computer). The program is then stored in the hard disk drive 7 and RAM 6 in the word processor. The CPU 4 reads and executes the program stored in such memory devices to realize the process described above.

The invention may be embodied in other specific forms without departing from the spirit or essential characteristics thereof. The present embodiment is therefore to be considered in all respects as illustrative and not respective, the scope of the invention being indicated by the appended claims rather than by the foregoing description and all changes which come within the meaning and range of equivalency of the claims are therefore intended to be embraced therein.

What is claimed is:

1. An apparatus for controlling a menu, comprising:
an icon display control section for displaying a first icon corresponding to a first function in relation to a second function within a second icon corresponding to the second function; and
a function control section for executing the function corresponding to the icon selected from the first and second icons being displayed.

2. The apparatus according to claim 1, wherein said second function is defined as a large classification and said first function is defined as a small classification belonging to said large classification.

3. The apparatus according to claim 1, wherein said first icon is displayed in a first menu image located at a hierarchically lower level of a second menu image and said second menu image.

4. A method for controlling a menu, comprising the steps of:
displaying, on a display image, a first icon corresponding to a first function in relation to a second function within a second icon corresponding to the second function; and
executing the function corresponding to the icon selected from said first and second icons being displayed.

5. The method according to claim 4, wherein said second function is defined as a large classification and said first function is defined as a small classification belonging to said large classification.

6. The method according to claim 4, wherein said first icon is displayed in a first menu image located in the hierarchically lower level of a second menu image and said second menu image.

7. A computer-readable storage medium recording a program for controlling a computer, comprising:
means for displaying, on a display image, a first icon corresponding to a first function in relation to a second function within a second icon corresponding to the second function; and
means for executing the function corresponding to the icon selected from said first and second icons being displayed.

8. The storage medium according to claim 7, wherein said second function is defined as a large classification and said first function is defined as a small classification belonging to said large classification.

9. The storage medium according to claim 7, wherein said first icon displayed in a first menu image located at a hierarchically lower level of a second menu image and said second menu image.
